(19) United States
(12) Patent Application Publication
(10) Pub. No.: US 2005/0048183 A1
(43) Pub. Date: Mar. 3, 2005

(54) Low carbohydrate pasta

(76) Inventor: Michael Yagjian, La Canada Flintridge, CA (US)

Correspondence Address: SHELDON & MAK, INC, 225 SOUTH LAKE AVENUE, 9TH FLOOR, PASADENA, CA, 91101, US

(21) Appl. No.: 10/648,556

(22) Filed: Aug. 25, 2003

(51) Int. Cl. A23L 1/00

(52) U.S. Cl. 426/557

(57) ABSTRACT

The invention satisfies this need. The invention is a pasta suitable for preparing a stuffed pasta product. The pasta is prepared from a mixture comprising: (a) soy protein; (b) wheat gluten; (c) soy flour; (d) a stabilizer capable of providing the mixture with sufficient strength, flexibility and elasticity for the mixture to be formed into an envelope having a hollow core (e) water; and (f) egg whites. In one embodiment, the stabilizer is provided by a gum, such as konjac flour and/or an alginate.

### FIELD OF THE INVENTION

This invention relates generally to food products and, more specifically, to pasta products.

### BACKGROUND OF THE INVENTION

Food products having reduced carbohydrate content have become very popular. Diets of low carbohydrate content have been credited with a large number of physiological advantages.

Attempts have been made to produce pasta products having low carbohydrate content but with little success. This is especially true in the attempts to produce a low carbohydrate pasta product suitable for preparing a stuffed pasta product, such as ravioli or manicotti. Proposed formulations for low carbohydrate pasta products lack sufficient strength, flexibility and elasticity to form a stuffed pasta product.

Accordingly, there is a need for a low carbohydrate pasta product suitable for preparing a stuffed pasta product.

### SUMMARY OF THE INVENTION

The invention satisfies this need. The invention is a pasta suitable for preparing a stuffed pasta product. The pasta is prepared from a mixture comprising: (a) soy protein; (b) wheat gluten; (c) soy flour; (d) a stabilizer capable of providing the mixture with sufficient strength, flexibility and elasticity for the mixture to be formed into an envelope having a hollow core with a volume of between 0.001 in³ and 0.5 in³; (e) water; and (f) egg whites.

In one embodiment, the stabilizer is provided by a gum, such as konjac flour and/or an alginate.

### DETAILED DESCRIPTION OF THE INVENTION

The following discussion describes in detail one or more embodiments of the invention and several variations of that embodiment. This discussion should not be construed, however, as limiting the invention to those particular embodiments. Practitioners skilled in the art will recognize numerous other embodiments as well.

The invention is a pasta suitable for preparing a stuffed pasta product. The pasta is prepared from a mixture comprising: (a) soy protein, (b) wheat gluten, (c) soy flour, (d) a stabilizer, (e) water and (f) egg whites.

The soy protein can be a soy protein isolate such as ProFam825 marketed by ADM Protein Specialties of Chicago, Ill. In a typical embodiment of the invention where the soy protein is a soy protein isolate, the soy protein constitutes 20%-25% by weight of the mixture.

The wheat gluten can be any wheat gluten commonly found on the market. In a typical embodiment of the invention, wheat gluten comprises 15%-20% by weight of the mixture.

The soy flour can be any of the soy flours commonly found in the market. In one embodiment, the soy flour is a toasted soy flour. Toasted soy flours add additional flavor to the pasta. One toasted soy flour suitable for use in the invention is toasted soy flour product TSF-63160 marketed by Cargill, Inc. of Cedar Rapids, Iowa. In a typical embodiment of the invention using toasted soy flour, the toasted soy flour constitutes 20%-25% by weight of the mixture.

The stabilizer must be capable of providing the mixture with sufficient strength, flexibility and elasticity for the mixture to be formed into an envelope having a hallow core with a volume between about 0.001 in³ and 0.5 in³, most typically a hallow core with the volume of between 0.001 in³ and 0.2 in³.

In one embodiment, the stabilizer is a gum such as konjac flour, an alginate or combinations thereof. Where the mixture comprises an alginate, the alginate can be a sodium alginate. In a typical embodiment of the invention wherein the stabilizer is a combination of konjac flour and sodium alginate, the konjac flour constitutes 0.5%-1.0% by weight of the mixture and the alginate constitutes 0.2%-0.8% by weight of the mixture. One konjac flour usable in the invention is marketed as Konjac-A, by Gum Technology Corporation of Tucson, Ariz. One alginate suitable in the invention is marketed as Algin SA by Gum Technology Corporation of Tucson.

In a typical embodiment of the invention, water constitutes 25% -35% by weight of the mixture and egg whites constitute 3% -6% by weight of the mixture.

The mixture can be formulated into a pasta envelope having a hallow core with a volume between 0.001 in³ and 0.5 in³ by a wide variety of machinery and techniques. One such piece of machinery comprises a pair of concentric tubes, an outer tube and an inner tube separated by an annulus. The pasta mixture is extruded through the annulus to form a pasta tube and pasta stuffing material such as meats, vegetables or combination thereof is extruded through the inner tube to fill the interior of the pasta tube. After the stuffed pasta tube is extruded from the pair of concentric tubes, the pasta tube can be severed at predetermined lengths. Either in this severing process or thereafter, the ends of the pasta tube can be crimped, if desired, to form a wholly enclosed stuffed chamber within the pasta.

### EXAMPLE

In one example of the invention, a mixture was prepared with 7.25 pounds of soy protein isolate, 6.125 pounds of wheat gluten, 7.25 pounds of toasted soy flour, 0.229 pounds of konjac four, 0.154 pounds of sodium alginate, 10 pounds of water and 1.5 pounds of egg whites.

The invention provides a low carbohydrate pasta product capable of being formed into pasta envelopes. Thus the invention provides for the first time a low carbohydrate pasta suitable for preparing stuffed pasta products.

Having thus described the invention, it should be apparent that numerous structural modifications and adaptations may be resorted to without departing from the scope and fair meaning of the instant invention as set forth hereinabove and as described hereinbelow by the claims.

1. A pasta suitable for preparing a stuffed pasta product, the pasta being prepared from a mixture comprising:
(a) soy protein;
(b) wheat gluten;
(c) soy flour;
(d) a stabilizer capable of providing the mixture with sufficient strength, flexibility and elasticity for the mixture to be formed into an envelope having a hollow core with a volume of between 0.001 in³ and 0.5 in³;
(e) water; and
(f) egg whites.

2. The pasta of claim 1 wherein the stabilizer is a gum.

3. The pasta of claim 1 wherein the stabilizer comprises a konjac flour.

4. The pasta of claim 1 wherein the stabilizer comprises an alginate.

5. The pasta of claim 1 wherein the stabilizer comprises both a konjac flour and an alginate.

6. The pasta of claim 1 wherein the stabilizer comprises a sodium alginate.

7. The pasta of claim 5 wherein the konjac flour constitutes 0.5%-1.0% by weight of the mixture.

8. The pasta of claim 4 wherein the alginate constitutes 0.2%-0.8% by weight of the mixture.

9. The pasta of claim 1 wherein the soy flour is a toasted soy flour.

10. The pasta of claim 1 wherein the soy protein constitutes 20%-25% by weight of the mixture.

11. The pasta of claim 1 wherein the soy protein is a soy protein isolate.

12. The pasta of claim 1 wherein the wheat gluten constitutes 15%-20% by weight of the mixture.

13. The pasta of claim 1 wherein the soy flour constitutes 20%-25% by weight of the mixture.

14. The pasta of claim 1 wherein water constitutes 25%-35% by weight of the mixture.

15. The pasta of claim 1 wherein egg whites constitute 3%-6% by weight of the mixture.

16. A pasta suitable for preparing a stuffed pasta product, the pasta being prepared from a mixture comprising:
(a) soy protein isolate;
(b) wheat gluten;
(c) toasted soy flour;
(d) konjac flour;
(e) an alginate;
(f) water; and
(g) egg whites.

17. The pasta of claim 16 wherein the konjac flour constitutes 0.5%-1.0% by weight of the mixture.

18. The pasta of claim 16 wherein the alginate constitutes 0.2%-0.8% by weight of the mixture.

19. The pasta of claim 16 wherein the wheat gluten constitutes 15%-20% by weight of the mixture.

20. The pasta of claim 16 wherein the soy flour constitutes 20%-25% by weight of the mixture.
